(19) United States
(12) Patent Application Publication
(10) Pub. No.: US 2024/0171222 A1
(43) Pub. Date: May 23, 2024

(54) Wave-Controlled Reconfigurable Intelligent Surfaces

(71) Applicant: The Regents of the University of California, Oakland, CA (US)

(72) Inventors: Filippo Capolino, Irvine, CA (US); Ender Ayanoglu, Irvine, CA (US); Arnold Lee Swindlehurst, Irvine, CA (US)

(21) Appl. No.: 18/283,975

(22) PCT Filed: Mar. 22, 2022
(86) PCT No.: PCT/US22/21398

§ 371 Date: Sep. 25, 2023

Related U.S. Application Data
(60) Provisional application No. 63/166,775, filed on Mar. 26, 2021.

(51) Int. Cl. H04B 7/04

(52) U.S. Cl. CPC H04B 7/04013

(57) ABSTRACT

Wave-controlled reconfigurable intelligent surfaces in accordance with embodiments of the invention are disclosed. In one embodiment, a wave-controlled reconfigurable intelligent surface for wireless communication may include a first layer comprising a plurality of unit cells devoted to providing local reflection properties via one or more tuning components in each unit cell of the plurality of unit cells, a system of one or more biasing transmission lines configured to provide control, and where at least one transmission line is configured for biasing the one or more tuning components using at least one full-domain basis function.

### CROSS-REFERENCE TO RELATED APPLICATION

The current application is a National Stage of International Application No. PCT/US22/21398, filed on Mar. 22, 2022, which claims priority to U.S. Provisional Patent Application No. 63/166,775, filed on Mar. 26, 2021, the disclosures of which are incorporated herein by reference.

### FEDERAL FUNDING SUPPORT

This invention was made with Government support under Grant No. 2030029, awarded by the National Science Foundation (NSF). The Government has certain rights in the invention.

### FIELD OF THE INVENTION

The present invention generally relates to wireless communications and more specifically to reconfigurable intelligent surfaces utilizing electromagnetic wave controls.

### BACKGROUND

For many years, the communications engineering community has been investigating and developing multiple-input multiple-output (MIMO) wireless systems. MIMO is now part of various communication standards, and is deployed throughout the world. A version of the MIMO concept, known as massive MIMO, employs orders of magnitude more antennas (10s or 100s) than MIMO, and achieves dramatic gains in spectral efficiency. Massive MIMO has moved from a theoretical concept to part of the Fifth Generation (5G) cellular wireless New Radio (NR) standard.

Several equipment manufacturers have introduced 64-antenna massive MIMO base stations, and service providers are rolling out 5G services with massive MIMO included. Work on massive MIMO raised the issue of pilot contamination as a problem that could potentially limit the capacity of such systems. However, when a multi-cell scenario is considered and under more realistic spatially correlated propagation conditions, this problem may be circumvented, and the practical capacity limits for massive MIMO may be well beyond what was previously thought possible.

### SUMMARY OF THE INVENTION

The various embodiments of the present wave-controlled reconfigurable intelligent surfaces contain several features, no single one of which is solely responsible for their desirable attributes. Without limiting the scope of the present embodiments, their more prominent features will now be discussed below. After considering this discussion, and particularly after reading the section entitled “Detailed Description,” one will understand how the features of the present embodiments provide the advantages described herein.

In a first aspect, a wave-controlled reconfigurable intelligent surface for wireless communication is provided, the wave-controlled reconfigurable intelligent surface comprising: a first layer comprising a plurality of unit cells devoted to providing local reflection properties via one or more tuning components in each unit cell of the plurality of unit cells; a system of one or more biasing transmission lines configured to provide control; and wherein at least one transmission line is configured for biasing the one or more tuning components using at least one full-domain basis function.

In an embodiment of the first aspect, the at least one full-domain basis function comprises a voltage wave over the whole transmission line.

In another embodiment of the first aspect, the plurality of unit cells are periodically arranged.

In another embodiment of the first aspect, the plurality of unit cells comprises a single-polarization or dual-polarization patch or slot or other scatterer like dielectric resonator, in each unit cell.

In another embodiment of the first aspect, the plurality of unit cells comprises patterned copper patches or patterned slots in a metal layer, or patterned dielectric resonator.

In another embodiment of the first aspect, the plurality of unit cells comprises metal patches or slots in a metal layer.

In another embodiment of the first aspect, the plurality of unit cells comprises patterned dielectric resonators.

In another embodiment of the first aspect, the plurality of unit cells comprises patterned dielectric element mixed with patterned metallic structures in each unit cell.

In another embodiment of the first aspect, the first layer provides controlled wave reflection.

In another embodiment of the first aspect, the tuning component is a varactor.

In another embodiment of the first aspect, wherein waves used for control comprise standing waves obeying electromagnetic boundary conditions of the guiding transmission line in one dimension.

In another embodiment of the first aspect, wherein waves used for control comprise a set of voltage standing waves.

In another embodiment of the first aspect, the wave-controlled reconfigurable intelligent surface further comprises at least one feeding line.

In another embodiment of the first aspect, control is exerted via the at least one feeding line.

In another embodiment of the first aspect, the at least one transmission line biases the one or more turning components without interfering significantly with an incoming radio frequency (RF) wave.

In another embodiment of the first aspect, the at least one transmission line is configured for biasing the one or more tuning components using at least one biasing mode that travels with a phase velocity V_{b} over a length Lₓ, along a first direction.

In another embodiment of the first aspect, a biasing-standing wave is established when the at least one transmission line is closed on short circuits, or an open circuit, or a designed load.

In another embodiment of the first aspect, the at least one biasing mode further comprises a transmission line propagation wavenumber k_{b} and guided wavelength λ_{b}.

In another embodiment of the first aspect, the at least one biasing mode comprises a number Pₓ of biasing modes where the Pₓ is a total number of degrees of freedom.

In another embodiment of the first aspect, the at least one transmission line is greater in length than the length Lₓ of the first layer to avoid providing almost zero voltage biasing control to a last unit cell of the plurality of unit cells.

In another embodiment of the first aspect, the at least one basis function comprises a frequency of excitation fₚ determined by establishing a resonance on at least one transmission line.

In another embodiment of the first aspect, wherein the wave-controlled reconfigurable intelligent surface has a length L′ₓ that is greater than a wavelength such that resonance frequencies are smaller than an electromagnetic RF frequency used in the communications link.

In another embodiment of the first aspect, an envelope polarization voltage is provided at each of the plurality of unit cells.

In another embodiment of the first aspect, a controlling wave comprising a linear superposition of periodic modes, wherein a sum of periodic mode voltages provides biasing to varactors that determine phase shifts.

In another embodiment of the first aspect, a controlling wave comprising a linear superposition of periodic modes is achieved in two dimensions (x and y) to control planar reconfigurable intelligent surfaces.

In another embodiment of the first aspect, a controlling wave comprising a linear superposition of modes is achieved in curvilinear dimensions to control curved (conformal) reconfigurable intelligent surfaces.

In another embodiment of the first aspect, a controlling wave comprising a linear superposition of modes traveling in two directions is achieved in two curvilinear dimensions to control curved (conformal) reconfigurable intelligent surfaces.

### BRIEF DESCRIPTION OF THE DRAWINGS

The various embodiments of the present wave-controlled reconfigurable intelligent surfaces will be discussed in detail with an emphasis on highlighting the advantageous features. These embodiments depict the novel and non-obvious features of wave-controlled reconfigurable intelligent surfaces shown in the accompanying drawings, which are for illustrative purposes only. These drawings include the following figures:

FIG. 1 is a diagram illustrating a holographic multiple-input multiple-output (HMIMO) device operating as an active transceiver in accordance with an embodiment of the invention.

FIG. 2 is a diagram illustrating an HMIMO device operating as a passive reflector in accordance with an embodiment of the invention.

FIG. 3 is a diagram illustrating a reconfigurable intelligent surface (RIS)-aided wireless system in accordance with an embodiment of the invention.

FIG. 4 is a diagram illustrating use of machine learning (ML) for a RIS-aided wireless system in accordance with an embodiment of the invention.

FIG. 5 is a diagram illustrating a wave-controlled RIS in accordance with an embodiment of the invention.

FIG. 6 illustrates RIS phase at various cell positions for propagation of a single ray in accordance with an embodiment of the invention.

FIG. 7 illustrates RIS phase at various cell positions for propagation of multiple rays in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features. Turning now to the drawings, wave-controlled reconfigurable intelligent surfaces (may also be referred to herein as “wave-controlled RIS” or “RIS”) are further described below.

In many embodiments, wave-controlled reconfigurable intelligent surfaces may utilize methods for achieving improvements in spectral efficiency for massive MIMO, and at the same time enhance the co-existence of diverse wireless systems using holographic MIMO. A particular application of embodiments of the invention may enable creation of software-controlled RISs that may adaptively steer received electromagnetic energy in desired directions by employing one or more metasurface(s) with controllable phase shifting cells. Thus, among other uses, a RIS may modify the propagation environment in order to provide wireless access to users' locations that may not otherwise be reachable by a base station. Alternatively, a MS may steer the waves away from particular locations in space, to eliminate interference and allow for co-existence of the wireless network with other types of fixed wireless services (e.g., radars, unlicensed radio bands, etc.). Prior work has largely ignored the electromagnetic coupling effects inherent in MS implementations, and incorrectly assumed an ideal scenario where arbitrary phase shifts (quantized or not) may be achieved at each element of the surface. Instead, the current embodiments of the invention rely on a more realistic wave-controlled architecture that may properly account for the maximum possible change in phase that may be achieved by adjacent RIS elements. The current embodiments of the invention explore both the theory and implementation of such a wave-controlled RIS, and may include signal processing and machine learning methods that use wave-controlled RIS architectures in both point-to-point and multi-cell MIMO systems. Holographic MIMO in accordance with embodiments of the invention is further discussed below

### Holographic MIMO

Holographic MIMO (HMIMO) may be utilized as an enhancement of massive MIMO. HMIMO may be referred to by various different names, such as holographic RF system, holographic beamforming, large intelligent surfaces, or reflectarrays. In addition, various methods may be utilized to implement them. In several embodiments, an HMIMO may include one or more surfaces with approximately continuous aperture which may be used for enhancing wireless communication. These surfaces may actively generate beamformed RF signals and/or control the reflections of RF signals generated at other locations. In many embodiments, HMIMO may result in hardware with reduced cost, size, weight, and/or power consumption and may transform the wireless environment into a smart, programmable entity. Because passive HMIMO typically does not require down-conversion of the received waveforms for baseband processing, there may be no added thermal noise. HMIMO may be implemented from very low frequencies up to the THz range. HMIMO typically has very low latency, while amplify-and-forward relaying may introduce delay. Generally, the term holographic is used since the reception, manipulation and transmission of an electromagnetic field over a continuous aperture is similar to what occurs in optical holography.

In many embodiments, a first categorization for HMIMO systems may be based on their power consumption characteristics. HMIMO systems may be built using either active or passive circuit elements. An active HMIMO system may operate as a transceiver, employing energy-consuming radio frequency (RF) circuits and signal processing units embedded in the surface. Active HMIMO systems represent an evolution of massive MIMO because they place an even larger number of software-controlled antenna elements across a finite two-dimensional surface. An active HMIMO system with reduced inter-element spacing and consequently an increased number of antenna elements is called a large intelligent surface. On the other hand, passive HMIMO systems may be composed of inexpensive passive elements that either do not require a power supply, or that may operate using energy harvesting devices. Passive HMIMO systems may be attractive due to their ability to shape and forward radio waves without power amplifiers or RF chains, and hence with low energy consumption. As such, passive HMIMO structures may be deployed almost anywhere, and integrated into building walls, factory ceilings, etc.

In terms of hardware, HMIMO systems may be discrete or contiguous. A discrete implementation may be constructed by employing many discrete unit cells made of low-power materials that may be tuned via software control. These can be in the form of off-the-shelf electronic components such as varactors, liquid crystals, microelectromechanical systems (MEMS), reconfigurable metamaterials, etc. In the case of varactors or liquid crystals, a very large number of them may be integrated into a substrate using tools specially designed for this purpose. Reconfigurable materials, on the other hand, may be based on discrete “meta-atoms” with electronically steerable reflection properties (e.g., shift in phase, polarization, and/or amplitude). A contiguous HMIMO system may form a spatially continuous transceiving aperture by integrating an essentially infinite number of elements onto a limited surface area. Optical holography may offer a model of how systems with a continuous aperture operate. Both discrete and contiguous HMIMO systems may have very small switching times, for example, on the order of nanoseconds. Although the present embodiments are discussed in terms of discrete HMIMO systems, various other systems may be appropriate for the requirements of a specific application and may be utilized in accordance with embodiments of the invention.

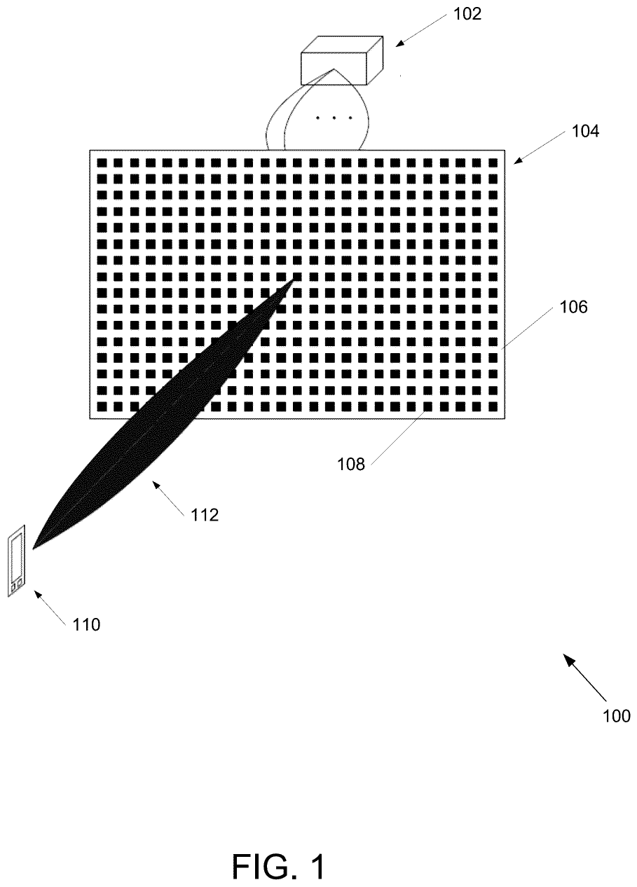

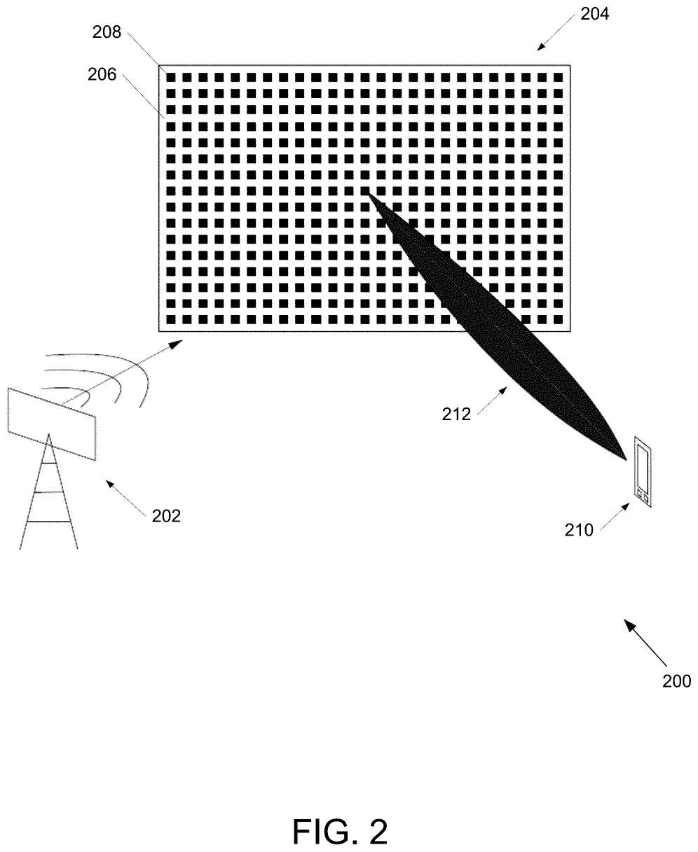

As discussed above, HMIMO systems may operate as either active transceivers or as passive reflectors. A diagram illustrating a holographic multiple-input multiple-output (HMIMO) device operating as an active transceiver in accordance with an embodiment of the invention is shown in FIG. 1. In reference to FIG. 1, the system 100 may include an RF signal generator 102 and an HMIMO device 104 operating as an active transceiver (may also be referred to as the “active transceiver” or “RIS”). In many embodiments, the active transceiver 104 may include a surface 106 with radiating elements 108 in communication 112 with a receiving user via a user's equipment 110. A diagram illustrating an HMIMO device operating as a passive reflector in accordance with an embodiment of the invention is sown in FIG. 2. In reference to FIG. 2, the system 200 may include an RF transmitter 202 and an HMIMO device 204 operating as a passive reflector (may also be referred to as the “passive reflector” or “RIS”). In various embodiments, the HMIMO device 204 may include a surface 206 with reflecting elements 208, in communication 212 with a receiving user via a user's equipment 210. In many embodiments, an active transceiver 104 or a passive reflector 204 may in turn be implemented with either a discrete or continuous HMIMO architecture, creating four different combinations. In the active transceiver mode, the RF signal may be generated behind the surface and propagate to the surface through a distribution network, as further described below. This network may be electronically steerable to generate multiple beams that can be transmitted to multiple users, as further described below. In the passive reflector mode, HMIMO may operate like a steerable mirror with reconfigurable unit cells, as further described below.

In various embodiments, HMIMO systems may be able to carry out a number of functions on electromagnetic waves that impinge on them. The following are the four most common types of these functions: i) Polarization: The impingent wave's polarization may be changed, ii) Reflection: A wave with a given arrival angle may be redirected towards one or more simultaneous desired directions, iii) Pencil Beamforming: The impingent wave may be focused to a given point in the near- or far-field of the array, iv) Absorption: The incoming wave may be absorbed by the surface, and reflection of the energy may be minimized.

HMIMO systems and/or devices may be planar or curved structures with a thickness of a few centimeters, and may be deployed in both outdoor and indoor scenarios, on building walls, stadium structures, within shopping malls, airports, etc. They may be employed to extend the range of the basestation (BS), connecting users with a blocked propagation path by reflecting electromagnetic waves from the BS around obstacles and in the direction of the user equipment (UE), as in a relay station. This may include extending BS coverage from outdoors to indoors. The ability to perform beamforming may enable the system to compensate for signal attenuation from the BS or to eliminate co-channel interference from neighboring B Ss. Compared with conventional relay-based approaches, HMIMO may offer the advantages of performing pencil-like beamforming and achieving increased energy efficiency. Such beamforming may have other uses, such as avoiding potential eavesdroppers if their locations are known by creating nulls in certain directions. Further, with HMIMO, the sidelobes associated with conventional beamforming may be eliminated, and therefore the security and energy efficiency of HMIMO systems may be substantially enhanced.

For illustrative purposes, the reflecting capabilities of HMIMO, as shown in FIG. 2, will be described in detail. For that reason, the term reconfigurable intelligent surface (RIS) will be used to describe various embodiments of the invention. In many embodiments, discussion on RISs may include the study of metasurfaces. Metasurfaces have a variety of applications, from high impedance surfaces that perform as artificial magnetic conductors to improve the antenna efficiency, as holographic leaky wave antennas, as polarization convertors, as reflect or transmit lenses, as sensors, or as analog devices that perform mathematical operations in real time, etc. Typically, research has focused on showing that tunable, controllable metasurfaces may improve communication links. The controllability and programmability of reflecting metasurfaces is one or the reasons they are referred to as RISs.

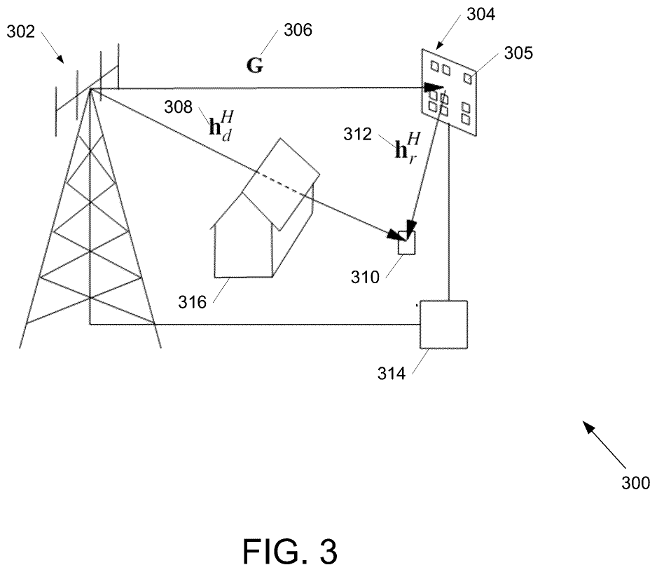

In various embodiments, a simplified model may assume that the RIS only introduces phase shifts; the more realistic case involving phase-dependent reflection amplitudes will be discussed further below. A diagram illustrating a reconfigurable intelligent surface (RIS)-aided wireless system 300 in accordance with an embodiment of the invention is shown in FIG. 3. In FIG. 3 a BS 302 employing an array of M antenna elements, and a RIS 304 with Nₓ elements 305 in each row and N_{y} elements 305 in each column for a total of N=NₓN_{y} elements, is illustrated. In various embodiments, it may be assumed that these elements introduce only phase shifts that may be individually controlled. In several embodiments, a channel 306 from the BS 302 to RIS 304 is denoted as G∈C^{N×M}, a direct channel 308 from the BS 302 to the UE 310 as h_{d}^{H}∈C^{1×M}, and a channel 312 corresponding to the reflected signal from the RIS 304 to UE 310 as hᵣ^{H}∈C^{1×N}. In some embodiments, the direct channel 308 from the BS 302 to the UE 310 may include an obstruction 316 such as, but not limited to, a building structure. In some embodiments, the system 300 may also include a controller 314. Further, the beamforming vector at the BS 302 may be denoted as w∈C^{M×1}, with the power constraint ∥w∥²≤Pₘₐₓ. In addition, it may be assumed that the signal transmitted by the BS 302 is s, which satisfies E[s²]=1. The received noise is assumed to have power σ². Each element 305 of the RIS 304 may introduce a phase shift θₙ∈[0, 2π], n=1, 2, . . . , N, which may be collected in the diagonal matrix Θ=diag(e^{jθ}^{₁}, e^{jθ}^{₂}, . . . , e^{jθ}^{_{N}}). Thus, the signal received by the UE 310 becomes

y=(hᵣ^{H}ΘG+h_{d}^{H})ws+n. (1)

The received signal-to-noise ratio (SNR) is

$$SNR = \frac{{\vert {h}_{r}^{H} Θ G + {h}_{d}^{H} \vert}^{2}}{{σ}^{2}} . \qquad ( 2 )$$

It is known that, for a single UE receiver, the beamforming method that maximizes the received SNR is maximum-ratio combining, which is expressed as

$${w}^{opt} = \sqrt{{P}_{max}} \frac{{h}_{r}^{H} Θ G + {h}_{d}^{H}}{‖ {h}_{r}^{H} Θ G + {h}_{d}^{H} ‖} . \qquad ( 3 )$$

As a result, a common RIS optimization problem to solve in order to maximize SNR is

$${max}_{Θ} {‖ {h}_{r}^{H} Θ G + {h}_{d}^{H} ‖}^{2} such that \vert Θ [ i , j ] \vert = 1. \qquad ( 4 )$$

Although specific HMIMO and RIS-aided systems are discussed above with respect to FIGS. 1-3, any of a variety of systems including HMIMO devices operating as active transceivers, passive reflectors, and various RIS-aided wireless systems as appropriate to the requirements of a specific application may be utilized in accordance with embodiments of the invention. Tunable and controlled Metasurfaces in accordance with embodiments of the invention are discussed further below.

### Tunable and Controlled Metasurfaces

A RIS may establish favorable wireless channel responses by controlling the multipath and the diversity of the wireless propagation environment through its reconfigurable passive metasurface elements. Prior work in the communication theory literature has assumed that the metasurface elements can be individually and arbitrarily controlled for this purpose. However, a critical observation that will serve the foundation of the present embodiments includes the observation that each element of a metasurface is electromagnetically coupled to its neighboring elements, via the dielectric substrate and/or via free space, and such observations should be taken into account, together with other constraints and hardware limitations. Furthermore, most existing work on reflecting metasurfaces and reflectarrays assume that each individual metasurface element totally reflects the incident power with an idealized phase shift with respect to the incident wave. However, due to electromagnetic coupling and losses this is typically not possible.

In many embodiments, tunable metasurfaces in the GHz range may be realized through the use of one or more varactor diodes that may provide a tunable capacitance via a biasing voltage. In various embodiments, the biasing voltage may be modulated over time (on the order of milliseconds) in order to change the reflectance properties of the metasurface, accommodating uses with time-varying channel conditions. Tunability using varactor diode biasing for metasurfaces may be considered the easiest and most natural approach. Various realizations may be proposed connecting one or two varactors to each element of the metasurface. For example, arrayed metallic patch elements on a grounded dielectric slab may be connected to two varactors, each to control a reflected polarization. Different designs may lead to various ranges of phase shifts and relatively stable reflection coefficient amplitudes across frequency and phase. Designs with multiple varactors can be used also for controlling the RIS over a wide bandwidth.

While prior work has emphasized exerting control on each element of the metasurface, the current embodiments illustrate that such approach is both unnecessary and also expensive in terms of fabrication, implementation, and programmability. For example, a metasurface composed of 100×100 elements would require a control reaching (via wires or printed circuits) each of the 10,000 unit cells. This doubles if we assume dual polarization operation. Furthermore, such control requires an optimization over 10,000+ parameters. As further described below, the current embodiments provide an alternative solution that would greatly simplify this approach. Machine learning for RIS in accordance with embodiments of the invention are discussed further below.

### Wave-Controlled RIS: Estimation of Physically Realizable Cell-to-Cell Control of Reflection Properties

The reflection properties of the RIS should be modulated in space across a reflecting surface, so the properties of one or more unit cells may be varied (e.g., tuned via varactors) across the surface. As discussed above, it may not possible to control the electromagnetic-field reflection properties from cell to cell of a metasurface. Indeed, it may not even be proper to discuss the problem in terms of individual-cell “reflection” because reflection is a collective phenomenon generated by the constructive interference of radiation arising from several unit cells. Typically, the concept of the “unit cell reflection property” is the reflection coefficient evaluated by a fully periodic structure, i.e., with all unit cells equal to each other (i.e., a phase gradient). This term is also used when a metasurface is generating a change of direction in the reflected beam, according to the generalized Fermat principle (or generalized Snell law). In many embodiments, control of the reflected beam direction may be obtained by applying a proper linear phase shift across the metasurface dimension. For example, when a beam is incident from a direction ψᵢ, the reflected beam may be reflected along a direction ψᵣ≠ψᵢ when a gradient of phase of the “local” reflection coefficients occurs across the surface. Here, the invention does not simply aim at generating a beam deflection, but at having a metasurface that reconfigures itself in time, and its scattering/reflection properties may be much more complicated than those previously studied, i.e., they can generate multiple beams or even complex radiation patterns to equalize the channel, including polarization control, and exploiting also very complex concepts like cell “chirality” and “omega” anisotropy.

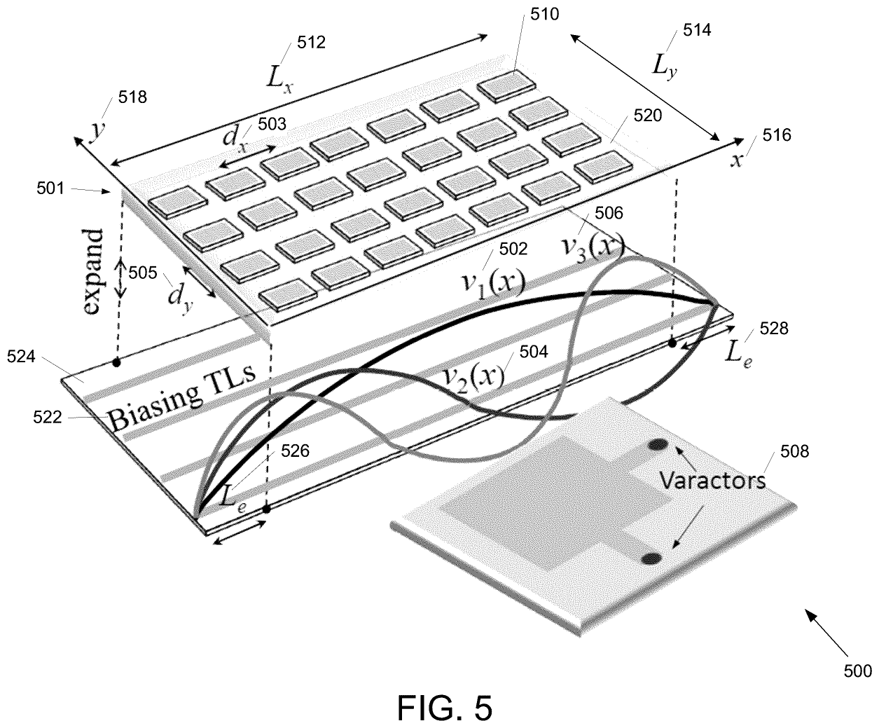

A diagram illustrating a wave-controlled RIS in accordance with an embodiment of the invention is shown in FIG. 5. When different voltage biases are applied to varactors 508 in adjacent unit cells, a desired phase shift of the “locally” reflected field may be produced, but the actual (desired) phase shifts across the metasurface cells does not follow the same arbitrarily controlled voltage variation that is applied to the varactors 508. In other words, the realized phase shift of the locally reflected fields across the surface may be smoothed out because of all possible couplings via free space and via the dielectric substrate. In several embodiments, these couplings may occur in the so called “near field” and therefore can be significant.

In various embodiments, it may be an important task to determine the maximum achievable change of reflection properties from cell to cell (in terms of phase shifts and amplitude and polarization variations), in two possible regimes of operation: wide band (that would be able to cover various mobile users), and tunable narrow bands (a few narrow bands that can be tuned to serve multiple users). In some embodiments, the reflection performance may depend on the geometry adopted for a unit cell, and it may be examined to determine the range of phase variation, as well possible bands of operation, for each of them. For example, unit cells made of patches, bow tie antennas, etc., including more complicated examples that work at wider bands may be considered. More precisely, given a metasurface 501 having a top layer 510 with lateral dimensions equal to Lₓ 512 and L_{y} 514, as illustrated in FIG. 5, denoted by θ(mdₓ, nd_{y}) the phase of the local reflection coefficient θ(x, y) at the m, nth cell at location (mdₓ, nd_{y}). The maximum phase gradient ∂θ(mdₓ, nd_{y}) ax along the x direction 516 that a metasurface can support by applying lumped reactances that vary from unit cell to cell may be determined. The same may also be done for the phase gradient ∂θ(mdₓ, nd_{y})/∂y along the y direction 518. The determination of the maximum realizable phase gradient may be important for the next step, which is to infer the number of degrees of freedom available to exert comprehensive control of the scattering properties of the RIS 510. Indeed, the phase of the local reflection coefficient at each unit cell and the reactance load X(mdₓ, nd_{y}) that can be applied to each unit cell at (x, y)=(mdₓ, nd_{y}) may be differentiated.

In many embodiments, numerical full-wave simulation methods may be used to analyze the electromagnetic scattering of unit cells by attaching reactances as lumped loads to each unit cell of the metasurface. Numerically, periodic boundary conditions may be applied first to evaluate how the phase of the locally reflected wave θ(x, y) may be changed in two respects: i) as a function of the reactance attached to the unit cells, and ii) along the x and y directions, by applying a phase gradient to the reflection phase of its elements. Then, small metasurfaces with a size of 20-30 elements in one direction, say x, and assumed to have infinite size in the other direction, say y, may be analyzed to generate the deflected radiation pattern upon plane wave illumination and provided reflection-phase shifts applied to each unit cell. In various embodiments, the relation between the field-phase gradient ∂θ(mdₓ, nd_{y})/∂x and the reactance-load gradient ∂X(mdₓ, nd_{y})/∂x may be determined.

Metasurfaces usually are large in terms of wavelengths, involving many small scale (subwavelength) features, and therefore numerical simulations may be time consuming. A typical approach has been to simulate a single-periodic unit cell. This approach may be accurate when the metasurface is “uniform” in its excitation, i.e., when the excitation across the surface is linearly phased (also called pseudo periodic excitation, like that provided by a plane wave). However, in many applications, various parts of the metasurface should provide different reflection characteristics and therefore a numerical method using periodic boundary conditions may not necessarily be accurate. However, the current embodiments may be based on having a reduced number of degrees of freedom that provide a smoother phase function θ(x, y) across the surface. Indeed, modulating (in space) the reflection properties, not from cell-to-cell but rather over a larger scale, from groups-to-groups of cells may be utilized. Therefore, the so called “local periodicity condition” used in the numerical full-wave modelling of the metasurface, typically used in the design of reflectarrays and metasurfaces, may be expected to be accurate. Although specific wave-controlled RISs are discussed above with respect to FIG. 5, any of a variety of wave-controlled RISs as appropriate to the requirements of a specific application may be utilized in accordance with embodiments of the invention and are further described below. Control of reflection properties of wave-controlled RISs in accordance with embodiments of the invention are further discussed below.

### Wave-Controlled RIS—Robust but Simplified Control of Reflection Properties

Once the number of degrees of freedom to generate a RIS field scattering is determined for a few representative metasurface geometries, focus may be placed on modeling long metasurfaces in one direction, say x, while in the other dimension, say y, the metasurface is assumed to be infinitely long so a single unit cell in they direction is numerically simulated using full-wave methods. In many embodiments, this methodology may enable observations of the effects of the locally reflected-field variation in a much faster way than use of rectangular metasurfaces, with finite-lengths in both directions, without compromising the generality of the results. A set of “full-domain” basis functions to control the phase shift of each unit cell across the RIS in the x direction may be applied. For example, if the RIS has Nₓ unit cells in the x direction, a maximum number Nₓ of individual controls may be applied.

In various embodiments, a relatively small number of degrees of freedom Pₓ<Nₓ may be enough to generate the variety of field variation to enhance the performance of MIMO links. Two observations may be illustrated: i) to demonstrate that the set of full-domain basis functions is sufficient for reproducing very complicated scattering properties from the RIS, and ii) to show the variations possible in the RIS-reflected field at a given location, for a variety of BS, user, and RIS configurations. Design considerations of scattering freedom using a programmable RIS for wave-controlled RISs in accordance with embodiments of the invention are discussed further below.

### Wave-Controlled RIS—Design Considerations of Scattering Freedom Using a Programmable RIS

As described above, the scattering/reflection capabilities of aRIS architecture using full-wave simulations may be illustrated. In addition, a prototype with phase-shift tunability for each unit cell in the x direction may be fabricated, as further described below. In many embodiments, wave-controlled RISs 500 may include a laminated metasurface 501 where the top layer 510 has a periodic arrangement of unit cells 520 (may also be referred to as “RIS elements”) made of patterned copper patches 520 attached to a varactor 508, which may be connected to one or more biasing lines below the ground plane 524 as shown in FIG. 5. In some embodiments, dₓ 503 and d_{y} 505 may define the distances between unit cells 520 in the x and y directions, respectively. In various embodiments, the bias may be administered using one or more transmission lines (TLs) that do not interfere with the incoming and reflected RF waves. The TL used for biasing the varactors 508 (may also be referred to as the “biasing TL” 522, four biasing TLs illustrated in FIG. 5) may support (biasing) modes that may travel with phase velocity v_{b} over the length Lₓ 512 of the metasurface 501 along the x direction 516. In several embodiments, a biasing mode may have a TL-propagation wavenumber k_{b}=ω/v_{b} and guided wavelength λ_{b}=2π/k_{b}=v_{b}/f_{b}, where f_{b} is the frequency of the biasing mode launched at the beginning of the biasing TL 522. A number Pₓ of biasing modes, described as Vₚ(x)=Vₚ exp(−jk_{b,p}x), where p=1, 2, . . . , Pₓ, and Pₓ is the total number of degrees of freedom discussed previously may be used to control the scattering properties of the RIS 500. The wavenumbers are k_{b,p}=ωₚ/v_{b}, where ωₚ is the frequency used to control the pth biasing mode. In the above equation, Vₚ=vₚe^{jφv,p} are the complex weights of the biasing modes that are provided by the excitation at frequency ωₚ. In various embodiments, the total voltage in the biasing TL 522 may be given by the sum of all the biasing modes V(x)=Σ_{P=1}^{Px} Vp exp(−jk_{b,p}x).

Power consumption of biasing lines closed on the loads and the option of closing the biasing TL 522 on short circuits, and how these two solutions affect the flexibility in assigning proper biasing to the varactors, may be considered. When the biasing TL 522 is closed on short circuits, a biasing-standing wave may be established. To avoid short-circuiting the first and last cells of the metasurface 501, the biasing line 522 may be longer than Lₓ 512 (the size of the RIS) by a small extra length Lₑ 526, 528 on each side, as shown in FIG. 5, such that the biasing line length is Lₓ′=Lₓ+2Lₑ. After normalization, the voltage standing wave phasor on the biasing TL 522 is V(x)=Σ_{P=1}^{Px} Vp sin(k_{b,p}x+φ_{e,p}), where φ_{e,p}=k_{b,p}Lₑ. The first three standing waves (p=1, 2, 3) (i.e., v₁(x) 502, v₂(x) 504, v₃(x) 506) that enable the wave-control are shown in FIG. 5. The proper frequency of excitation fₚ=ωₚ/(2π) of the standing wave may be determined by establishing a resonance that, neglecting loading along the TL, satisfies the two boundary conditions V (x=Lₑ)=0 and V(x=L′ₓLₑ)=0, leading to ωₚ=pπv_{b}/L′ₓ. In many embodiments, the goal may be to use a RIS with size L′ₓ much larger than a wavelength, so that the resonance frequencies are much smaller than the electromagnetic RF frequency used in the communications link; this simplicity may enable the wave-controlled method, and hence the use of the reduced degrees of freedom.

In various embodiments, it may be assumed that the loading of the biasing TL at each unit cell is negligible and that the phase velocity v_{b} of the waves in the biasing TL has low frequency dispersion, although this should be carefully calculated using both full-wave methods and experimental characterization. However, since the biasing modes are quasi-TEM, dispersion does not play a major role. In several embodiments, it may be assumed that the standing wave may be used to provide a polarization bias to the varactors, located at positions mdₓ. The time-domain field representation of the standing biasing wave is

$$υ ( x , t ) = {V}_{0} + {\sum }_{p = 1}^{{P}_{x}} {υ}_{p} sin ( {k}_{b , p} x + {ϕ}_{e , p} ) cos ( {ω}_{p} t + {ϕ}_{υ , p} ) , \qquad ( 5 )$$

where a constant DC bias voltage V₀ may be added to polarize the varactors. This may provide an envelope polarization voltage at each RIS element. By properly choosing the excitation of each biasing TL mode Vₚ, a large degree of variation of biasing to the varactors after a proper detection method is used may be provided.

In many embodiments, design of metasurfaces with wave-based control using 1D and 2D full-domain basis functions as degrees of freedom should be considered. The metasurfaces may include of a variety of metallic patches 520 arranged periodically on the top layer 510, shown in FIG. 5, each connected to a set of varactors 508 to electronically control the local wave reflection coefficient θ(mdₓ, nd_{y}) and provide the desired phase distribution across the metasurface 501. Consideration may be given to providing the correct biasing voltages to the varactors 508 at locations (mdₓ, nd_{y}) using 1D and 2D full-domain basis functions and proper envelope detection methods. In addition, consideration may be given to terminating the biasing TLs 522, and finding a compromise between power consumption and tuning flexibility. Furthermore, methods to detect the standing wave voltage to be transformed into a DC bias for each varactor may be considered. Although specific wave-controlled RISs are discussed above with respect to FIG. 5, any of a variety of wave-controlled RISs as appropriate to the requirements of a specific application including, but not limited to, planar and/or curved (conformal) based RISs may be utilized in accordance with embodiments of the invention. For example, in some embodiments, wave-controlled RISs may be achieved utilizing planar structures such as, but not limited to, two dimensional (e.g., x and y) structures. Furthermore, in some embodiments, wave-controlled RISs may be achieved utilizing curved (conformal) structures such as, but not limited to, two curvilinear dimension based structures. Unit cell “reflection” models for wave-controlled RISs in accordance with embodiments of the invention are discussed further below.

### Wave-Controlled RIS Unit Cell “Reflection” Model Based on Full-Domain Basis Functions

In some embodiments, the one-dimensional (x) description as described above may be generalized to two dimensions x and y, defining the operation of the N=NₓN_{y} cells of the RIS over both dimensions, as well as P=PₓP_{y} two-dimensional complex-valued basis function coefficients V_{pq}. Further, two operators θ=F_{θ}(X) and X=F_{V}(V) that respectively define how the N reactance loads X=X(mdₓ, nd_{y}) may be determined by the P biasing voltage parameters V=V_{pq}, and in turn the local phase shifts θ=θ(mdₓ, nd_{y}) may be determined by reactance loads X. The composition of the two operators leads to the total operator F_{θ}V=F_{θ}F_{V} that relates the local reflection phases θ(mdₓ, nd_{y}) to the controlling voltage weights V_{pq}. By approximating the response of each metasurface unit cell (using the local periodicity approximation), a square matrix representing F_{θ} may be considered and its elements determined using analytical approximations in terms of zeros and poles. The other operator F_{V} may be determined by the type of varactors used, i.e., by the degree of variation of the varactors' capacitance as a function of the DC bias V₀ and the small signal AC bias represented by the phasors V_{pq}. Further consideration may be given to include the fact that the local reflection coefficients may not be unitary in magnitude, therefore the local reflection coefficients may be described by magnitudes r(mdₓ, nd_{y})<1 in addition to the local phases θ(mdₓ, nd_{y}).

In several embodiments, models may be constructed that provide the phase of the local reflection coefficients θ(mdₓ, nd_{y}) of the N=NₓN_{y} unit cells as a function of the P=PₓP_{y} complex weights V_{pq} that describe the biasing voltage function. Such models may provide the two operators F_{θ} and F_{V}, and hence their composition leading to θ=F_{θ}F_{V} (V). Reduced dimension considerations for wave-controlled RISs in accordance with embodiments of the invention are discussed further below.

### Reduced Dimension Considerations

Wave-controlled RIS architectures, as described above, may have important implications on how wireless system performances may be optimized. In many embodiments, wave-controlled RIS architectures may be symbiotic with various types of propagation environments for which RISs have been proposed, as further described below. One of the challenges associated with a system employing a RIS may be to determine the best values for the phase shifts of the RIS cells, and then communicating these values to the RIS. Approaches that have been proposed to date attempt to determine each of the individual phase shifts independently of the others, assuming either that the phases are continuously adjustable, or are quantized to a resolution of a few bits. It has been shown that an asymptotic SNR gain of O(N²) may be achieved even with only a one-bit quantization of the phase, but there is still a considerable gap in performance between the quantized and unquantized cases. In either case, finding the elements of Θ is typically posed as a large non-convex optimization problem that should be solved for each user and each channel coherence interval, and then transmitted to the RIS.

As described above, achieving an arbitrary local phase shift at each cell of the RIS may not possible due to inherent electromagnetic coupling effects. Further, such detailed control may not be necessary, at least in the types of situations for which RIS architectures have been typically proposed, where LoS (or near-LoS) conditions hold (e.g., millimeter wave or terahertz frequencies). Consideration of the model in (1) for the case where h_{d}=0 and the common assumption of LoS propagation holds provides insights. Assuming far-field propagation for simplicity (the argument does not change appreciably for a spherical wave model), the UE channel may be represented as hᵣ=βᵣa(ψᵣ), where βᵣ is a path gain common to all RIS elements, ψᵣ=[ψ_{r,a} ψ_{r,e}]^{T} represents the reflected vector angle of departure (AoD, including azimuth ψ_{r,a} and elevation ψ_{r,e} angles) of the signal from the RIS, and a(ψᵣ) is the corresponding array response for a signal propagating with direction ψᵣ. For example, if the RIS is a rectangular array, the elements of a(ψᵣ) would have the form

exp(j2π(mdₓ sin ψ_{r,a}+nd_{y} cos ψ_{r,a} sin ψ_{r,e})/λ) (6)

for integer indices m, n, where λ is the signal wavelength and dₓ, d_{y} are the distances between RIS elements in the x and y directions. For simplicity, a single polarization may be considered, but the current embodiments as described herein may be applied in situations with dual-polarized antennas. Similarly, G would be a rank one matrix of the form

G=β_{b}a(ψᵢ)a_{b}^{H}(ψ_{b}), (7)

where β_{b} is the large scale fading coefficient between the BS and RIS, ψ_{b} is the vector AoD of the signal from the BS, a_{b} is the array response of the BS, and ψᵢ is the vector angle of arrival incident at the RIS. As further described below, the structure inherent in the problem may provide a much simpler RIS operation.

In many embodiments, the choice of Θ that may maximize the SNR in (2) for this model may be given by

Θₒₚₜ=e^{jα}diag^{H}{a(ψᵢ)}diag{a(ψᵣ)}, (8)

where diag is a diagonal matrix formed from its vector input, and α is an arbitrary phase offset that has no impact on the SNR. Since the locations of the BS and RIS are typically fixed and presumably known, ψᵢ is known, so Θₒₚₜ only depends on the 2 parameters in ψᵣ. Eq. (8) holds even if there are phase-dependent variations in the magnitude of the reflection coefficient. If the diagonal elements of the optimal solution in (8) are reshaped into a matrix of the same dimension as the RIS, for the case of a uniformly spaced rectangular geometry, the optimal solution may be a 2-dimensional complex sinusoid.

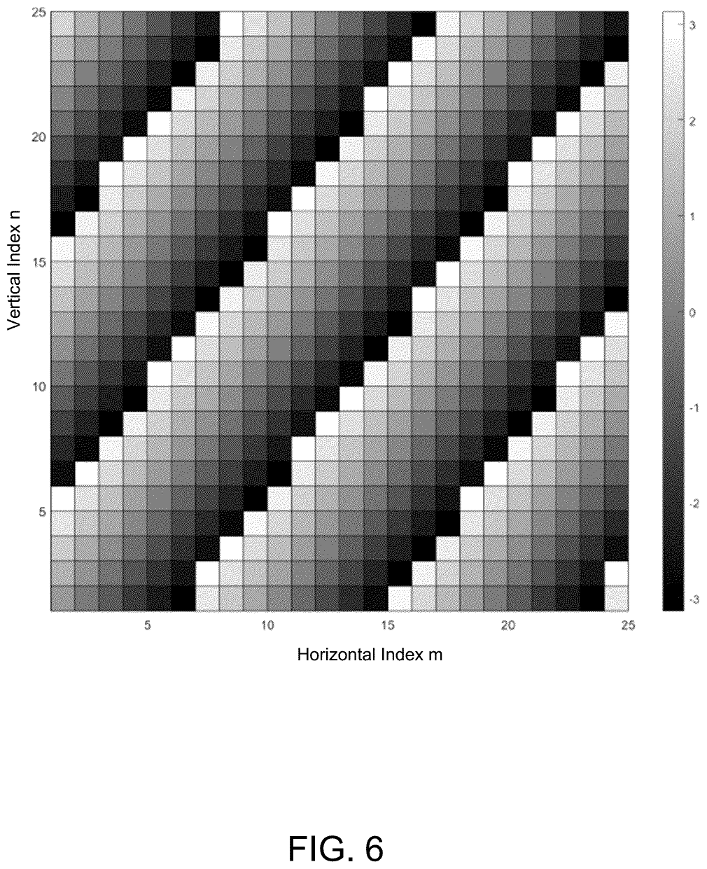

RIS phase at various cell positions in accordance with an embodiment of the invention is shown in FIG. 6. As illustrated, FIG. 6 shows the optimal phase shifts for a case with dₓ=d_{y}=λ/5, ψᵢ=[30°, −15° ] and ψᵣ=[−5°, 15° ]. In many embodiments, the phase function may be periodic and thus highly spatially correlated, and control of every RIS element to an arbitrary phase may be unnecessary. Furthermore, given the arbitrary e^{ja} offset, the actual value of the phase of each element may not be important; it is instead the phase difference between elements that determines the directionality of the resulting propagation. This smooth periodic phase profile is fortuitous given the constraints described above on the element-to-element phase variation due to electromagnetic coupling. (Note that the sharp transition from white to black for some of the cells in FIG. 6 does not represent a large change in phase due to the inherent 2□-periodicity of the phase function).

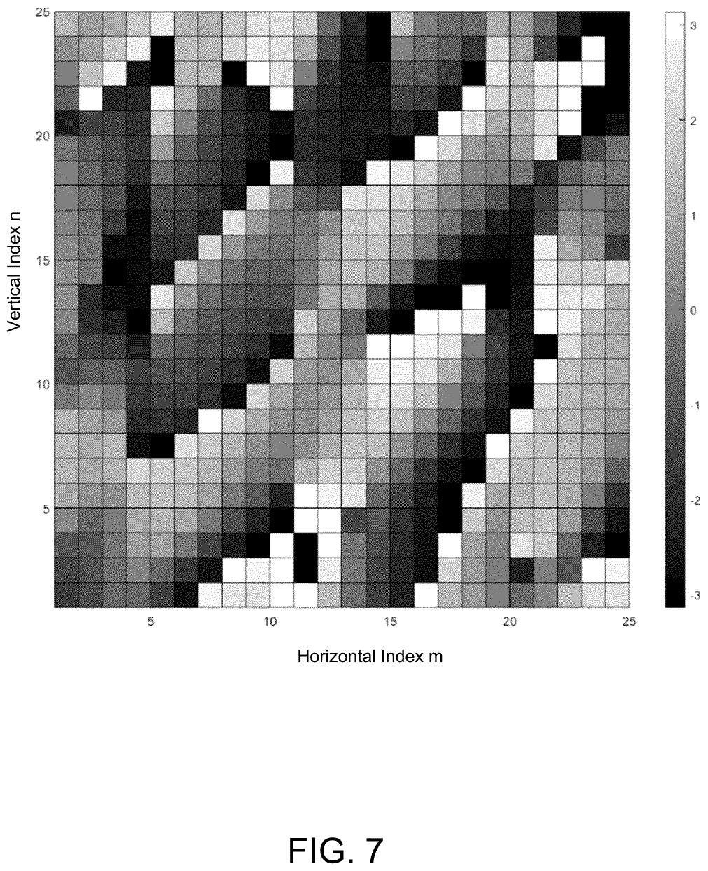

In various embodiments, the above observations are not restricted to pure LoS situations, and may hold true in environments with somewhat more complicated propagation, including a few discrete multipaths or for near-field spherical wave propagation, since again the channel, and hence the RIS phase profile, will depend on many fewer than N parameters. This is illustrated in FIG. 7, which shows the optimal phase shifts for a case where the RIS interacts with 5 planewaves randomly distributed in azimuth and elevation. Once again, we see the high degree of spatial correlation in the desired RIS response. In such cases the optimization may not be direct as in (8), but may include many fewer parameters than N. The reduced-dimension control of the biasing voltage in (5) provides P=PₓP_{y}«N degrees of freedom in which to control the local wave reflection coefficient θ(mdₓ, nd_{y}), and it is thus the P coefficients V_{pq} that should be optimized in order to control the operation of the RIS. The desired sinusoidal variation of the phase to maximize the SNR may be a good match to the sinusoidally varying biasing modes described above. The limited number of modes P not only accounts for the maximum phase change that is physically realizable from cell to cell, it also reduces the dimension of the required optimization and the resulting information that should be communicated to the RIS. This may be a critical issue since a separate optimization and control signal may be required for every user with which the BS is using the RIS to communicate.

The current embodiments, focus may be placed on methods that do not inherently quantize the phase, but simply restrict the variation in the element-to-element phase using analog bias voltages derived by the modes in the underlying waveguide control. A smooth phase profile composed of a sum of a small number of two-dimensional sinusoids may in principle be achieved by an intelligent superposition of the modes of the biasing control in (5). A key practical factor to consider is how to account for the boundary conditions on the bias voltages that will in turn limit the choice of the possible basis functions. As described above, a possible solution may be to increase the length of the waveguides beyond the outermost cell edges, to force the boundary conditions to occur in positions where they do not significantly constrain the bias voltage that may be achieved at the edge cells of the metasurface. Another important factor that may be considered is the use of the RIS to serve multiple users at once, even under LoS propagation conditions, by means of frequency-division multiplexing (FDM). Most prior work has focused on narrowband implementations with time-division multiplexing in LoS settings, but the current wave-controlled RIS architectures may be suitable for wider bandwidths where FDM is possible.

Using the functional relationship F_{θV}=F_{θ}F_{V} described above and which translates the biasing voltage parameters V to the corresponding local phase shifts θ realized by the RIS, methods for optimizing the RIS in order to maximize link performance metrics for both single- and multi-user settings may be considered. Further, optimization may consider the impact of the reflection coefficient amplitude, which is known to vary with phase. While the resulting objective function remains non-convex, the non-convex unit modulus constraint is removed, and the number of parameters is significantly reduced. Results should demonstrate the importance of exploiting the high degree of spatial correlation inherent in the high-frequency channels where RIS will be deployed. Although specific RIS phases are discussed above with respect to FIGS. 6 and 7, any of a variety of RIS phases at various cell positions as appropriate to the requirements of a specific application may be utilized in accordance with embodiments of the invention. Sparse UE channel parameter considerations for wave-controlled RISs in accordance with embodiments of the invention are discussed further below.

### System Level Experimental Demonstration of the Benefit Provided by the RIS in a MIMO System

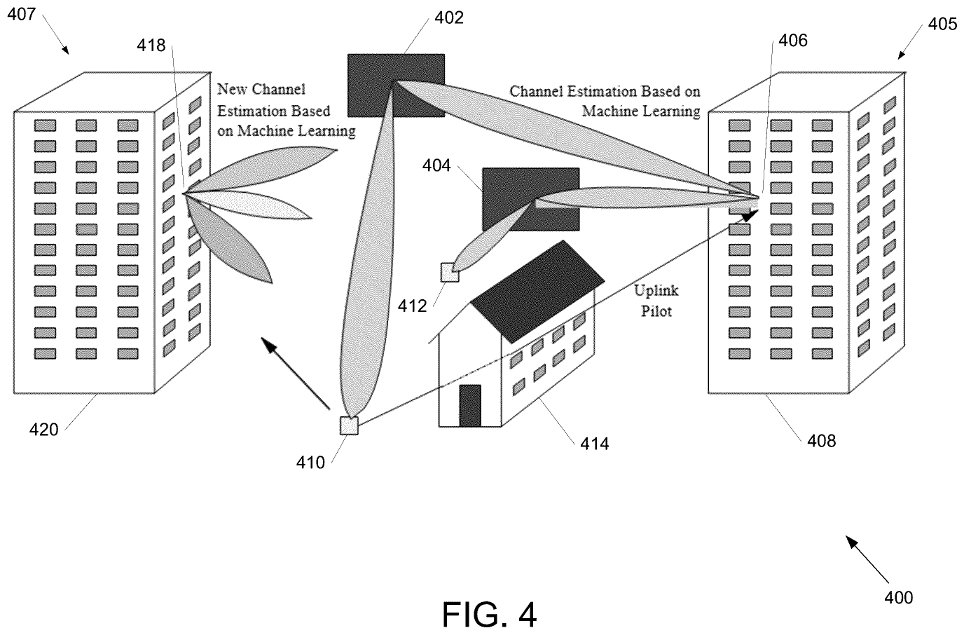

A MIMO system level demonstration may be conducted using a RIS fabricated as described above. An experimental set-up in accordance with an embodiment of the invention is shown in FIG. 4. In many embodiments, the system 400 may include one or more MIMO transceivers (e.g., RIS1 402, RIS2 404), a first basestation 405 that may include antenna elements 406 located on a wall of a first building 408, one or more UEs (e.g., UE1 410, UE2 412), one or more obstructions (e.g., structure 414), a second basestation 407 that may include antenna elements 420 located on a wall of a second building 420. For example, the MIMO system may include two MIMO transceivers (e.g., RIS1 402 and a RIS 2 404) operating under two distinct scenarios. In the first scenario there may be no obstacles between the two transceivers, while in the second an obstacle covered by absorbing panels between them may be placed, with the RIS located in proximity as illustrated in FIG. 4. In many embodiments, the MIMO transceivers may be implemented with multi-antenna such as (but not limited to) Ettus USRP N200/N210 software radios that may be synchronized via connection to a controller (e.g., a PC-based controller) that may also provide the control signaling to the RIS. The first phase of experiments for each scenario may involve cycling the RIS bias control through a series of different configurations (basis coefficients) while the receiver repeatedly transmits training data. In various embodiments, the degree to which the RIS may facilitate estimation of the channel between the transceivers and the RIS, and the number of parameters that are reasonably required to describe the channel may be demonstrated. In the second phase, based on the estimated CSI from the first phase, optimization of the RIS reflection properties in a fixed setting using computer-based control of the RIS biasing voltages may be demonstrated. In several embodiments, the improvement in SNR may be quantified as a function of the number of wave basis functions employed in the optimization, as well as for various channel geometries. The third phase may involve a moving receiver, demonstrating the ability of the system to close the loop in real time, continuously updating the CSI based on intermittent training and spatial correlation information from previous data frames. Although specific experimental set-ups are discussed above with respect to FIG. 4, any of a variety of experimental set-ups as appropriate to the requirements of a specific application may be utilized in accordance with embodiments of the invention. Additional considerations and advantages in accordance with embodiments of the invention are discussed further below.

### Additional Considerations and Advantages

Spectral Efficiency—The addition of a RIS in a wireless network may enhance the ability of a BS and UEs to close a communication link that would not be possible otherwise. For example, UEs in locations that are difficult-to-reach due to blockages or shadowing may still be served by exploiting reflections to/from a large RIS. Thus, a user who would otherwise experience an outage may still be served by the BS, thus improving the UE's access to the spectrum and the overall efficiency of the system. Even in the absence of any blockage, the RIS may provide a wireless channel that is more conducive to higher rate transmission (e.g., a higher-rank channel) that may allow a UE to achieve greater throughput within the same frequency band. The RIS can further decorrelate the channels of UEs operating in the same frequency band; funneling the signal to a user through the RIS effectively changes its communication channel, and such changes may be exploited to make the channels to different users closer to orthogonal. This enhances the ability of a BS to achieve spatial multiplexing gain and higher throughput to users in the same frequency band.

Co-Existence—The ability of a RIS to change the characteristics of the wireless propagation environment has many potential uses in terms of improving wireless co-existence. As discussed above, a RIS may create or enhance spatial separability among co-channel users by pointing beams in directions away from fixed co-channel users such as radars, or simply by reducing the transmitted power that would otherwise be required to overcome poor propagation conditions in the natural environment. For example, consider FIG. 4, and assume that the building 414 employs its own wireless receivers, using Wi-Fi in an unlicensed band or as a facility with radar or microwave antennas. If the cellular network with a BS 405 on the face of the building 408 on the right wants to use the same unlicensed band, the RISs can in effect “bend” the signal around the red-roof building in order to eliminate interference that would disrupt the co-existence. MIMO generally provides this type of ability, but the RIS may be viewed as enhancing it in an adaptive way. In general, a large-dimension RIS may achieve very narrow beams with low sidelobes that reduce interference leaked towards unintended directions.

Low-Cost Versatile Wireless Technology—A RIS provides a low-cost adaptive method for enhancing wireless communications by modifying the characteristics of the wireless propagation environment. The type of RIS many include a passive device that does not require high-cost, high-power amplifiers or RF hardware, but nonetheless provides a large number of degrees of freedom for flexibly defining how the wireless signals may be reflected. While massive MIMO base stations are typically provided with 64 antennas in products available from equipment manufacturers today, the addition of a few RISs to a network may effectively add hundreds to thousands of controllable scatterers to the environment that effectively multiply the versatility of massive MIMO by 2-3 orders of magnitude. In effect, the RIS may function similar to an ELAA, and they may be deployed essentially anywhere, indoors or outdoors, and thus may facilitate many different types of networks.

Cross-Layer Design—The addition of a RIS to a wireless network may provide numerous opportunities for exploiting cross-layer coupling beyond the physical layer. For example, cellular handovers often occur when the serving BS signal is blocked or shadowed, and another BS is found that, at least temporarily, has a better channel condition. At higher (e.g., millimeter wave) frequencies, this can occur simply by rotating one's head in a way that blocks the LOS path from the BS. When blockages like this are frequent, the overhead associated with these handovers consumes significant system resources and creates serious operational inefficiencies. The use of a RIS may provide additional diversity to the wireless channel in order to reduce such inefficiencies. Among other topics, the current embodiments focus on the use of RIS together with channel charting for cellular handovers, which has significant advantages over conventional handover techniques such as not requiring supervision and being simpler to implement yet more accurate. Technological and transformative impact in accordance with embodiments of the invention are discussed further below.

### Technological and Transformative Impact

The current embodiments may be extended in many different directions. For example, the RIS structure of FIG. 2 may be extended to work as an active transceiver structure as depicted in FIG. 1. Further, wave-controlled RIS may be utilized to design arrays with reduced degrees of freedom. This is may have broader impact, since it may be utilized to design of ELAAs consisting of hundreds or even thousands of antenna elements that may be integrated into tall building walls, stadiums, ceilings of large buildings, etc. Since it has recently been shown that massive MIMO systems can theoretically have unlimited capacity, a tremendous increase in spectral efficiency may be realized. Furthermore, the current embodiments may be utilized in MIMO radar systems. Past performance analyses show that MIMO radar leads to significant performance improvement in direction finding accuracy and better target detection performance. Yet another application may include locating users, where location includes the device orientation in addition to position in xyz coordinates. These latter two uses of ELAAs may be significant for future applications such as (but not limited to) autonomous cars or unmanned airborne vehicles.

Although specific systems, methods, and design considerations are discussed above, any of a variety of systems, methods, and designs as appropriate to the requirements of a specific application may be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A wave-controlled reconfigurable intelligent surface for wireless communication, comprising:
a first layer comprising a plurality of unit cells devoted to providing local reflection properties via one or more tuning components in each unit cell of the plurality of unit cells;
a system of one or more biasing transmission lines configured to provide control; and
wherein at least one transmission line is configured for biasing the one or more tuning components using at least one full-domain basis function.

2. The wave-controlled reconfigurable intelligent surface of claim 1, wherein the at least one full-domain basis function comprises a voltage wave over the whole transmission line.

3. The wave-controlled reconfigurable intelligent surface of claim 1, wherein the plurality of unit cells are periodically arranged.

4. The wave-controlled reconfigurable intelligent surface of claim 1, wherein the plurality of unit cells comprises a single-polarization or dual-polarization patch or slot or other scatterer like dielectric resonator, in each unit cell.

5. The wave-controlled reconfigurable intelligent surface of claim 1, wherein the plurality of unit cells comprises patterned copper patches or patterned slots in a metal layer, or patterned dielectric resonator.

6. The wave-controlled reconfigurable intelligent surface of claim 1, wherein the plurality of unit cells comprises metal patches or slots in a metal layer.

7. The wave-controlled reconfigurable intelligent surface of claim 1, wherein the plurality of unit cells comprises patterned dielectric resonators.

8. The wave-controlled reconfigurable intelligent surface of claim 1, wherein the plurality of unit cells comprises patterned dielectric element mixed with patterned metallic structures in each unit cell.

9. The wave-controlled reconfigurable intelligent surface of claim 1, wherein the first layer provides controlled wave reflection.

10. The wave-controlled reconfigurable intelligent surface of claim 1, wherein the tuning component is a varactor.

11. The wave-controlled reconfigurable intelligent surface of claim 1, wherein waves used for control comprise standing waves obeying electromagnetic boundary conditions of the guiding transmission line in one dimension.

12. The wave-controlled reconfigurable intelligent surface of claim 1, wherein waves used for control comprise a set of voltage standing waves.

13. The wave-controlled reconfigurable intelligent surface of claim 1 further comprising at least one feeding line.

14. The wave-controlled reconfigurable intelligent surface of claim 13, wherein control is exerted via the at least one feeding line.

15. The wave-controlled reconfigurable intelligent surface of claim 1, wherein the at least one transmission line biases the one or more turning components without interfering significantly with an incoming radio frequency (RF) wave.

16. The wave-controlled reconfigurable intelligent surface of claim 1, wherein the at least one transmission line is configured for biasing the one or more tuning components using at least one biasing mode that travels with a phase velocity V_{b} over a length Lₓ, along a first direction.

17. The wave-controlled reconfigurable intelligent surface of claim 16, wherein a biasing-standing wave is established when the at least one transmission line is closed on short circuits, or an open circuit, or a designed load.

18. The wave-controlled reconfigurable intelligent surface of claim 16, wherein the at least one biasing mode further comprises a transmission line propagation wavenumber k_{b} and guided wavelength λ_{b}.

19. The wave-controlled reconfigurable intelligent surface of claim 16, wherein the at least one biasing mode comprises a number Pₓ of biasing modes where the Pₓ is a total number of degrees of freedom.

20. The wave-controlled reconfigurable intelligent surface of claim 19, wherein the at least one transmission line is greater in length than the length Lₓ of the first layer to avoid providing almost zero voltage biasing control to a last unit cell of the plurality of unit cells.

21. The wave-controlled reconfigurable intelligent surface of claim 1, wherein the at least one basis function comprises a frequency of excitation fₚ determined by establishing a resonance on at least one transmission line.

22. The wave-controlled reconfigurable intelligent surface of claim 1, wherein the wave-controlled reconfigurable intelligent surface has a length L′ₓ that is greater than a wavelength such that resonance frequencies are smaller than an electromagnetic RF frequency used in the communications link.

23. The wave-controlled reconfigurable intelligent surface of claim 1, wherein an envelope polarization voltage is provided at each of the plurality of unit cells.

24. The wave-controlled reconfigurable intelligent surface of claim 1, wherein a controlling wave comprising a linear superposition of periodic modes, wherein a sum of periodic mode voltages provides biasing to varactors that determine phase shifts.

25. The wave-controlled reconfigurable intelligent surface of claim 1, wherein a controlling wave comprising a linear superposition of periodic modes is achieved in two dimensions (x and y) to control planar reconfigurable intelligent surfaces.

26. The wave-controlled reconfigurable intelligent surface of claim 1, wherein a controlling wave comprising a linear superposition of modes is achieved in curvilinear dimensions to control curved (conformal) reconfigurable intelligent surfaces.

27. The wave-controlled reconfigurable intelligent surface of claim 1, wherein a controlling wave comprising a linear superposition of modes traveling in two directions is achieved in two curvilinear dimensions to control curved (conformal) reconfigurable intelligent surfaces.
